(19) United States
(12) Patent Application Publication
(10) Pub. No.: US 2022/0258765 A1
(43) Pub. Date: Aug. 18, 2022

(54) METHOD FOR MODELING THE SURROUNDINGS OF AN AUTOMATED VEHICLE

(71) Applicant: Robert Bosch GmbH, Stuttgart (DE)

(72) Inventors: Roman Gansch, Renningen (DE); Peter Munk, Renningen (DE); Andreas Heyl, Weil Der Stadt (DE)

(21) Appl. No.: 17/666,757

(22) Filed: Feb. 8, 2022

(30) Foreign Application Priority Data
Feb. 17, 2021 (DE) 10 2021 201 512.3

(51) Int. Cl. B60W 60/00; B60W 50/00; G06F 30/13

(52) U.S. Cl. CPC B60W 60/0015; B60W 50/0098; G06F 30/13; B60W 2050/0028; B60W 2556/35; B60W 2420/52; B60W 2556/60; B60W 2554/00; B60W 2420/42

(57) ABSTRACT

A method for modeling the surroundings of an automated vehicle in which environment information is continuously received from currently available information sources. Each information source provides pieces of environment information. A formal assumption and a formal guarantee is associated with each piece of environment information in such a way that it is guaranteed, if the formal assumption associated with the respective piece of environment information is fulfilled, that the piece of environment information fulfills the formal guarantee associated with it. Each information source provides the associated formal assumptions and formal guarantees for the pieces of environment information it supplies. A piece of environment information is used for calculating the world model at a given point in time only if the formal assumption associated with this piece of environment information is fulfilled at this point in time.

### FIELD

The present invention relates to a method and a device for modeling the surroundings of an automated vehicle. The present invention further relates to a computer program.

### BACKGROUND INFORMATION

U.S. Patent Application Publication No. US 2018/292834 A1 describes a method using sensor and map data to determine a vehicle trajectory. If an object is detected in the surroundings of the vehicle by an external sensor (a camera or a radar sensor in the vehicle) and the movement of the object intersects with the vehicle trajectory, the movement of the vehicle is adjusted accordingly. At any point in time, it is assumed that all data, particularly those of the external sensor and the map data, are completely available and correct.

U.S. Patent Application Publication No. US 2020/276983 A1 discloses a method to determine whether two objects acquired by different sensors are in fact the same object. This determination takes into account whether the detected objects are moving.

Sweden Patent Application No. SE 1750156 A1 relates to a method for the autonomous or partially autonomous clearing of an area using one or multiple clearing units, particularly snowplows. The method comprises collecting data concerning the conditions during clearing and the parameters of the clearing unit.

U.S. Patent Application Publication No. US 2018/025643 A1 relates to a method for handling inter-vehicle communication, in which the surroundings of the vehicle are detected.

Automated vehicles rely on perceiving their surroundings via sensors and detection algorithms to generate a world model that enables, e.g., a planner component of the automated vehicle to define the best approach for automated driving, e.g. in the form of a trajectory to be followed by the vehicle. At present, automated vehicles only use data supplied by sensors affixed to the respective vehicle itself for this purpose. Given the anticipated greater availability of V2X data (vehicle-to-vehicle, vehicle-to-infrastructure etc.), this will turn into a situation of distributed environment perception in the future. That means that external sensors having various perspectives may be used additionally to generate a world model of an automated vehicle. The challenges associated with such distributed perception include, for example, the dynamic change of the available sensors and generating a trustworthy world model from the environment information supplied by these sensors.

In this context, a world model is understood to be the internal perspective of the automated vehicle, which is generated based on the data acquired by the vehicle's own sensors and by the external sensors. For example, the world model may comprise the objects in the surroundings of the vehicle as well as current states of these objects such as, e.g., movement directions and speeds. The world model may further comprise environment conditions such as weather, road condition, and/or light conditions. The world model should be sufficiently accurate and complete to enable an automated vehicle to plan a safe trajectory within the world model. For this purpose, the information included in the world model not only must be as complete as possible, but also as reliable as possible. To this end, the perception of the surroundings must be as complete and reliable as possible.

The use of a contract-based design (CBD) approach is known in a static architecture to verify a signal chain of perception and to check the integrity of the generated world model. In this approach, a contract is associated with every component, i.e. a series of formal guarantees for its outputs and a series of the corresponding formal assumptions for its inputs. The guarantees of the component are valid if and only if the assumptions are fulfilled. The assumptions and guarantees of all components may be represented as a logic program at the time of creating a system and a so-called model checker may be used to verify an existing design. Model checking is a conventional method for fully automated verification of a system description against a specification.

### SUMMARY

The present invention relates to a method for modeling the surroundings of a driver assistance system or an automated vehicle. For modeling the surroundings of the vehicle, the method may use the vehicle's own sensors as sources of information, for example a camera or a radar sensor, as well as external data that are received from other vehicles or sources of the infrastructure, particularly weather services, GPS, or stationary sensors (e.g., cameras, radar sensors . . . ). Since the data received in such a manner from information sources outside of the vehicle may, for example, be incomplete, untrustworthy, or absent, it may not always be feasible to include all parameters when modeling the surroundings.

An object of the present invention is to provide a method and a device for modeling the surroundings of a driver assistance system or an autonomous or automated vehicle, the method or device taking these circumstances into account when modeling the surroundings and thus generating a reliable world model.

According to an example embodiment of the present invention, the modeling disregards data, or the environment information derived from such data, that are not or only partially available or that are not trustworthy, which is reflected in the fact that certain assumptions associated with these data are not fulfilled.

Parallel to this, the surroundings are modeled based on all available and trustworthy data. The model may be adjusted dynamically, for example if environment information from sensors outside of the vehicle is added or becomes unavailable.

According to a first aspect of the present invention, a method is provided for modeling the surroundings of an automated vehicle, the environment information being continuously received from a plurality of currently available vehicle-based and/or vehicle-external sources of information.

Such information sources may particularly include the vehicle's own environment sensors, such as radar sensors, lidar sensors, ultrasonic sensors, or cameras (mono and/or stereo cameras). Additionally, external environment sensors such as stationary cameras or rain sensors in the road infrastructure may be used as information sources. The respective environment information is generated from the measuring data acquired by the corresponding environment sensor. Alternatively or additionally, information sources may include data services, which may provide, e.g., current and local information about weather conditions, road conditions or similar as environment information. Information sources may be configured as a camera and/or radar sensor and/or rain sensor and/or lidar sensor and/or pressure sensor and/or GPS receiver and/or as a data service for environment data, particularly for weather data and/or traffic information and/or traffic control information.

The environment information preferably includes weather information and/or information about the sizes and/or positions and/or speeds and/or movement directions of objects in the surroundings of the vehicle and/or object classes and/or object lists and/or information about open spaces. A source of information may provide multiple pieces of environment information, for example, a camera may provide a list of acquired objects as well as their coordinates and the corresponding object classes (e.g., passenger car, bicycle, pedestrian . . . ) and/or movement information associated with the objects (e.g., speed and movement direction) as environment information. A formal assumption is associated with every piece of environment information. The corresponding environment information will only be used for generating the world model if this assumption is fulfilled.

In this connection, every information source provides one or multiple pieces of environment information, and a formal assumption and a formal guarantee is associated with every piece of environment information according to the principle of contract-based design. In addition to environment information, every information source also provides the formal assumptions and formal guarantees associated with the respective environment information. If the formal assumption associated with the corresponding environment information is fulfilled, then it is thereby guaranteed that the environment information fulfills the formal guarantee associated with it.

Preferably, one or a plurality of formal guarantees of specific pieces of environment information serve as formal assumptions for at least one other piece of environment information. An attempt is now made to mathematically generate a stable world model so that as many formal assumptions as possible are fulfilled. This ensures that as many of the available pieces of environment information as possible are incorporated in the world model, thus making the world model more reliable and safer.

In accordance with an example embodiment of the present invention, using the environment information received in this manner, at least one world model of the automated vehicle is thus calculated in such a way that a piece of environment information is only used for calculating the world model at a given point in time if the formal assumption associated with this piece of environment information are fulfilled at this point in time.

This achieves the technical advantage of it being possible to calculate a safe and stable world model, even in case of dynamically changing availabilities of information sources, or the environment information provided by them, particularly during runtime.

In one possible specific embodiment of the present invention, it is possible to determine a count of pieces of environment information that were not used due to unfulfilled formal assumptions and to determine on this basis a quality metric for the world model. In particular, there may be a provision that the world model is to be used further by the automated vehicle only when a specific quality measure is reached.

If a specific quality measure is not met, environment information may, for example, be requested from additional information sources, each additional information source again having an associated set of formal assumptions and formal guarantees. These further information sources may be used additionally for calculating the world model, again on condition that the formal assumptions are fulfilled.

In this manner, the quality, i.e., the stability and reliability, of the world model may be further improved.

It may be the case that not enough of the formal assumptions are fulfilled in order to derive a stable world model or to derive a stable world model with sufficient information, for example in the case of two components with circular dependencies between their respective assumptions and guarantees. In such a case, the automated vehicle is, e.g., transferred into a safe state, for example, it is stopped, or the control is handed over to a human driver.

To avoid this, in these cases the assumptions of individual pieces of environment information may be successively modified during the calculation of the world model in such a way that they are always fulfilled (set to true), and a plurality of stable world models may thus be derived for these modified assumptions. These stable world models represent different possibilities of the real world, taking into consideration the available information. If the planner is able to identify a safe trajectory in all of these possible world models, it is thus possible to prevent the automated driving operation from having to be interrupted.

Preferably, at least one piece of environment information may be provided, whose formal assumption is always fulfilled or assumed to be fulfilled. For example, it may be assumed that a stationary rain sensor is guaranteed to always provide a valid piece of environment information as to whether it is currently raining at the rain sensor location or not. No further formal assumption needs to be fulfilled for this, i.e. the formal assumption for the environment information “rain” may be assumed to be “true” (formally described by using a “true” statement as the assumption). In particular, this means that, based on the pieces of environment information not requiring any assumptions, a check may be started to determine whether using the resulting guarantees it is possible to fulfill assumptions for other information sources. This allows for the, in particular sequential, determination of a series of guarantees, whose assumptions may be fulfilled under the current conditions by the current set of sensors and information sources.

Preferably, there may be a further provision that a future world model is calculated based on a current world model. According to a preferred specific embodiment of the present invention, one or more safe trajectories may be calculated for the automated vehicle using at least a current and, if available, a future world model.

In a preferred specific embodiment of the present invention it may be possible, particularly over a longer time period, to identify those formal assumptions that are rarely or never fulfilled and to provide additional information sources based thereon, particularly infrastructure sensors that supply pieces of environment information that are able to fulfill these formal assumptions.

According to the present invention, the concept of “contract-based design” is thus expanded to the application case of distributed perception. An inherently reliable world model may thus be generated during runtime on the basis of the available pieces of environment information.

In other words, a model of the vehicle surroundings is thus generated based on the available data, it being possible to dynamically add or omit environment information or sensor data.

The present invention differs from conventional methods, for example, in that the decision whether a given set of pieces of environment information is able to provide a trustworthy and therefore reliable world model does not need to be made already at the stage of system development. All available pieces of environment information are collected in the form of contracts, i.e., using a set of formal assumptions and the resulting guarantees in each case, and the mutual dependencies between these contracts are resolved. In this manner, it is advantageously possible to successively generate a world model from all available pieces of environment information, preferably during runtime.

To this end, the contracts may be represented as clauses in a logic program. A so-called stable model, which indicates the currently existing guarantees, is derived by way of established methods such as ASP. Since these guarantees comprise the pieces of environment information, the stable model also represents a trustworthy world model for the safety requirements of the automated vehicle. In this manner, the assumptions and guarantees of all components may be represented as a logic program, and the world model may be generated dynamically, for example via “answer set programming” (ASP) during runtime. ASP is a declarative programming style that enables the definition of formal properties and relationships. Using these items of information, an ASP solver is able to combine them with one another to provide a so-called stable model, which fulfills these properties and relationships, or prove that such a model does not exist.

According to a second aspect of the present invention, a device is provided that is configured to execute a method according to the present invention. In accordance with an example embodiment of the present invention, the device comprises a fusion component, which is configured to continuously receive environment information from a plurality of vehicle-based and/or vehicle-external information sources and to calculate at least one world model for the automated vehicle as a function of the received environment information. The fusion component is configured to use a piece of environment information of an information source for calculating the world model at a given point in time only if the formal assumptions associated with this piece of environment information are fulfilled at this point in time, a check to determine whether the formal assumptions associated with a piece of environment information are fulfilled in particular being performed during runtime.

The device may be configured within an automated vehicle, e.g., as a part or a module of a control unit. Alternatively, the device may be configured outside of the vehicle, for example as a stationary unit having a communications module to receive environment information and the associated contracts (assumptions and guarantees) and to transmit a world model and/or information based on the world model to an automated vehicle.

In addition, in accordance with an example embodiment of the present invention, the device preferably comprises a planner component that is configured to calculate and provide to the automated vehicle one or more safe trajectories for the automated vehicle based on at least one world model calculated by the fusion component.

Alternatively it is also possible to provide the fusion component outside of the automated vehicle and to provide the planner component within the automated vehicle.

The formulation “automated vehicle” here comprises one or more of the following cases: assisted control, semi-automated control, highly automated control, fully automated control of the vehicle.

Assisted control means that a driver of the motor vehicle continuously controls either the lateral or the longitudinal guidance of the motor vehicle. The respectively other driving task (controlling the longitudinal or lateral guidance of the motor vehicle) is executed automatically. Accordingly, assisted control of a motor vehicle means that either the lateral or the longitudinal guidance is controlled automatically.

Semi-automated control means that in a specific situation (for example: driving on an expressway, driving in a parking lot, passing an object, driving within a lane defined by lane markings) and/or for a certain time period, a longitudinal and lateral guidance of the motor vehicle is controlled automatically. A driver of the motor vehicle does not have to manually control the longitudinal and lateral guidance of the motor vehicle. However, the driver must continuously monitor the automated control of the longitudinal and lateral guidance in order to be able to intervene manually if necessary. The driver must be ready to fully take over the motor vehicle operation at all times.

Highly automated control means that for a certain time period in a specific situation (for example: driving on an expressway, driving in a parking lot, passing an object, driving within a lane defined by lane markings), a longitudinal and lateral guidance of the motor vehicle is controlled automatically. A driver of the motor vehicle does not have to manually control the longitudinal and lateral guidance of the motor vehicle. The driver does not need to continuously monitor the automated control of the longitudinal and lateral guidance in order to be able to intervene manually if necessary. If necessary, a takeover request is issued automatically, particularly providing sufficient lead time, to prompt the driver to take over the control of the longitudinal and lateral guidance. That means the driver must be potentially able to take over the control of the longitudinal and lateral guidance. The limits of automatically controlling the longitudinal and lateral guidance are detected automatically. In the case of highly automated control, it is not possible to automatically bring about a minimal risk state in every initial situation.

Fully automated control means that in a specific situation (for example: driving on an expressway, driving in a parking lot, passing an object, driving within a lane defined by lane markings), a longitudinal and lateral guidance of the motor vehicle is controlled automatically. A driver of the motor vehicle does not have to manually control the longitudinal and lateral guidance of the motor vehicle. The driver does not need to monitor the automated control of the longitudinal and lateral guidance in order to intervene manually if necessary. Before the automated control of the longitudinal and lateral guidance ends, a takeover request is issued automatically, particularly providing sufficient lead time, to prompt the driver to take over the driving task (controlling the longitudinal and lateral guidance of the motor vehicle). If the driver does not take over the driving task, a minimal risk state is automatically restored. The limits of automatically controlling the longitudinal and lateral guidance are detected automatically. It is possible in all situations to restore the system to a minimal risk state.

Driverless control or guidance means that, regardless of a specific application case (for example: driving on an expressway, driving in a parking lot, passing an object, driving within a lane defined by lane markings), a longitudinal and lateral guidance of the motor vehicle is controlled automatically. A driver of the motor vehicle does not have to manually control the longitudinal and lateral guidance of the motor vehicle. The driver does not need to monitor the automated control of the longitudinal and lateral guidance in order to intervene manually if necessary. Accordingly, the longitudinal and lateral guidance of the motor vehicle is controlled automatically, for example on all types of roads and in all speed ranges and environment conditions. The complete driving task of the driver is thus taken over automatically, which means the driver is no longer needed. Thus, even without a driver, the motor vehicle is able to drive from any starting point to any destination point. Potential problems are solved automatically, i.e., without assistance from the driver.

The present invention provides the features of a cascading evaluation of the capability of an automated system in which a trustworthy world model is generated based on given inputs and fulfilled conditions or assumptions. These features have the following advantages, particularly in the application case of “distributed perception” in which the quantity of available environment information may change dynamically:

Based on pieces of environment information that do not require any assumption, it is possible to sequentially determine a series of guarantees that may be fulfilled under the current conditions, using the current set of sensors and information sources. This series of guarantees may be more extensive than the guarantees that would only be achievable based on the exclusive use of environment information acquired by vehicle-based sensors. Using these guarantees and the world model based thereon, it is possible to determine which safety-critical actions/behaviors may be executed at sufficiently low risk.

In the case that guarantees are not available for a specific desired safety-critical behavior, specific pieces of information may be actively requested from additional external sources (e.g. from further infrastructure sensors or from the assistance systems of other motor vehicles) to complete the “contract chain”, which results in the dynamic reconfiguration of the sensor set.

### BRIEF DESCRIPTION OF THE DRAWINGS

Specific embodiments of the present invention are described in detail with reference to the figures.

FIG. 1 shows a traffic setting with an automated vehicle in accordance with an exemplary embodiment of the present invention.

FIG. 2 in a schematic manner shows a device in accordance with an exemplary embodiment of the present invention.

FIG. 3 shows a flow chart of a method in accordance with an exemplary embodiment of the present invention.

Specific embodiments of the present invention are described in detail with reference to the figures.

### DETAILED DESCRIPTION OF EXAMPLE EMBODIMENTS

In the following description of specific embodiments of the present invention, identical elements are labeled with the same reference sign. Where applicable, these elements are not described repeatedly. The figures only represent the subject matter of the present invention in schematic form.

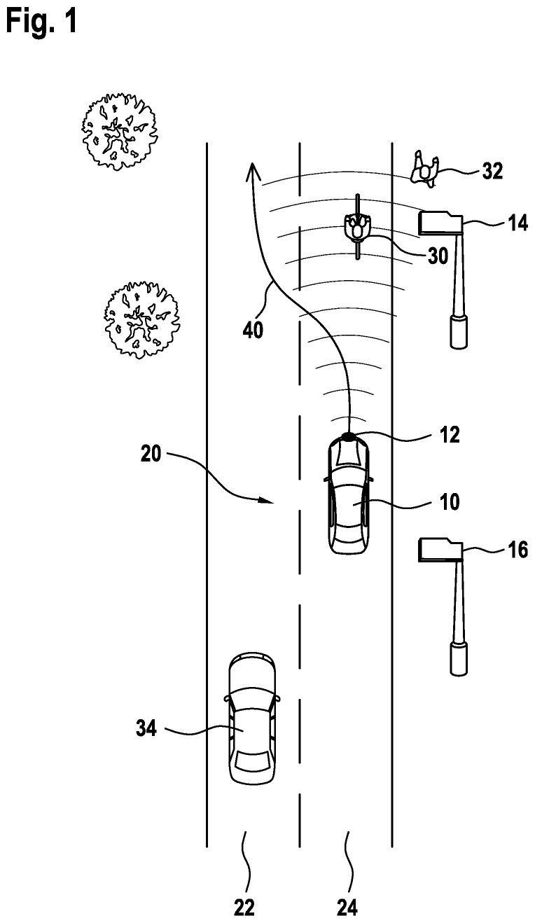

FIG. 1 shows an automated vehicle 10 driving in the right line 24 of a two-lane roadway 20. The vehicle comprises an environment sensor system that is configured to acquire measuring data about the surroundings of the vehicle and to generate environment information from these data. For example, the sensor system 12 may comprise one or a plurality of cameras and/or one or a plurality of radar sensors and/or one or a plurality of lidar sensors. The sensors of the sensor system 12 may, for example, acquire objects in the surroundings of vehicle 10 and localize and classify them based on the acquired measuring data. In the depicted situation, a bicycle 30, a pedestrian 32, and a further vehicle 34 in lane 22 are within the surroundings of the vehicle, in addition to various stationary objects.

Furthermore, the infrastructure of the roadway 20 comprises a plurality of stationary, vehicle-external, infrastructure-integrated sensors 14, 16, which also acquire and provide environment information about the current surroundings of vehicle 10 in the given situation. For example, sensors 14, 16 may include one or a plurality of cameras and/or one or a plurality of radar sensors and/or one or a plurality of rain sensors. In this example, sensors 14, 16 are configured to wirelessly transmit the environment information acquired by them to vehicle 10 and include appropriate communication modules for this purpose. Vehicle 10 in this example may receive the environment information wirelessly transmitted by sensors 14, 16 via a corresponding receiver module. Together with the ascertained pieces of environment information, sensors 14, 16 also transmit formal assumptions and guarantees associated with the pieces of environment information, it being guaranteed that, if the formal assumption associated with a piece of environment information is fulfilled, this piece of environment information fulfills the formal guarantee associated with it. The pieces of environment information generated by the vehicle-internal sensors of sensor system 12 also comprise such formal assumptions and guarantees.

Based on the received environment information and the associated assumptions and guarantees, it is now possible to calculate at least one world model of the surroundings of automated vehicle 10, for example by using an ASP solver implemented in a processing unit or a fusion component of vehicle 10, in such a way that a piece of environment information is only used for calculating the world model at a given point in time if the formal assumption associated with this piece of environment information is fulfilled at this point in time.

The world model generated in this manner in particular comprises all safety-relevant objects or open spaces in the surroundings of vehicle 10 so that, for example, a planner component of vehicle 10 is able to calculate one or more safe trajectories 40 for the automated vehicle 10 based on at least one world model calculated by the fusion component and to provide the trajectory/trajectories to the automated vehicle 10.

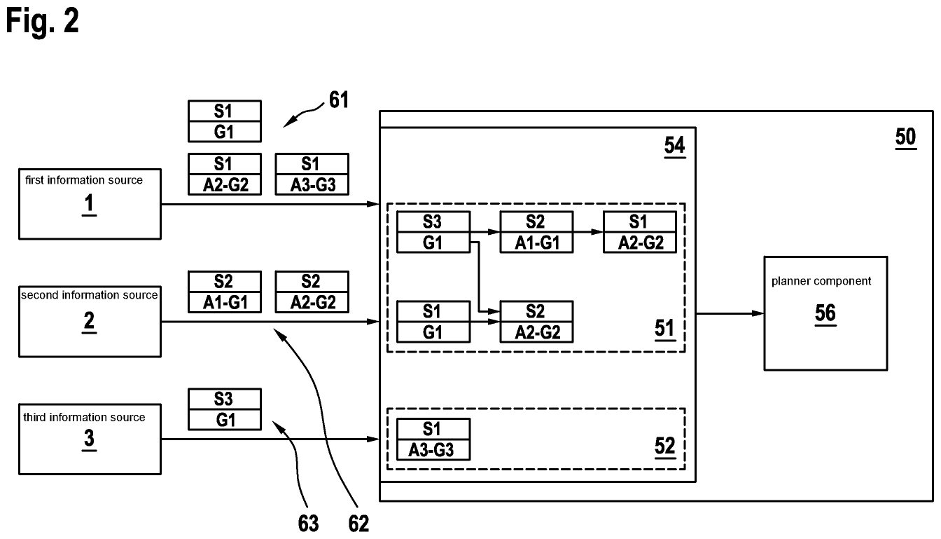

FIG. 2 in a schematic manner shows a device 50 for modeling the surroundings of an automated vehicle according to an exemplary embodiment of the present invention. Device 50 comprises a fusion component 54. The fusion component 54 continuously receives environment information from, in this example, three vehicle-based and/or vehicle-external information sources 1, 2, and 3. In this example, the first information source 1 is a vehicle-based camera. It is able to acquire, localize and classify objects in the vehicle environment. In addition, the camera is able to detect fog in the environment of the vehicle. The second information source 2 in the present example is configured as a vehicle-based radar sensor. It is able to acquire and localize objects in the vehicle environment. The third information source 3 in the present example is configured as a stationary rain sensor located outside of the vehicle. It is able to provide environment information to specify whether or not it is presently raining at its location. This environment information may, for example, be provided dynamically via car-to-infrastructure communication.

According to the present invention, a formal assumption and a formal guarantee is associated with each piece of environment information. Thus, each information source 1, 2, 3 transmits a set 61, 62, 63 of pieces of environment information and associated assumptions and guarantees, so-called contracts.

The table below lists examples of possible assumptions and guarantees of information sources 1, 2, 3 and of the pieces of environment information provided by information sources 1, 2, 3:

TABLE 1
Sensor 1: Camera (vehicle)

| | |
|---|---|
| Assumption S1-A1: true | Guarantee S1 A1-G1: fog or no |
| | fog |
| Assumption S1-A2: no other | Guarantee S1 A2-G2: object + |
| object in the vicinity of the | object class at a specific |
| detected object | coordinate (x, y, z) |
| Assumption S1-A3: no reflecting | Guarantee S1 A3-G3: object + |
| surface in the vicinity of the | object class at a specific |
| acquired object | coordinate (x, y, z) |

Sensor 2: Radar (vehicle)

| | |
|---|---|
| Assumption S2-A1: no rain | Guarantee S2 A1-G1: object |
| | at a specific coordinate |
| | (x, y, z) |
| Assumption S2-A2: no rain & no | Guarantee S2 A2-G2: |
| fog | object(s) at a specific |
| | coordinate (x, y, z) |

Sensor 3: Rain (weather transmitter)

| | |
|---|---|
| Assumption S3-A1: true | Guarantee S3 A1-G1: rain or |
| | no rain |

Depending on the received pieces of environment information and the assumptions and guarantees, fusion component 54 calculates at least one world model 51 of the automated vehicle during runtime, a piece of environment information of an information source 1, 2, 3 being used to calculate the world model at a given point in time only if the formal assumptions associated with this piece of environment information are fulfilled at this point in time. For this purpose, the attempt is made to fulfill as many of the present contracts as possible. This results in a cascade of dependencies, and it is possible, for example, to identify those pieces of environment information that cannot be included in the world model because their assumptions cannot be fulfilled.

In the above example it is noteworthy that the environment information as to whether fog is present or not, which is provided by the vehicle's own camera as information source 1, does not need to fulfill an assumption, i.e. the formal assumption S1-A1 is always “true”. As a result, it is guaranteed (guarantee S1 A1-G1) that a piece of environment information indicating whether fog is present or not is available in any case. Likewise, the environment information as to whether it is raining or not, which is provided by the external rain sensor as information source 3, does not need to fulfill an assumption, i.e. the formal assumption S3-A1 is always “true”. As a result, it is guaranteed (guarantee S3 A1-G1) that environment information indicating whether it is raining or not is available in any case. In contrast, the camera is only able to execute a reliable object classification and localization if no other object is acquired in the vicinity of a detected object (guarantee S1 A2-G2) and/or if no reflecting surface was detected in the vicinity of the acquired object (guarantee S1 A3-G3). The radar sensor is able to reliably acquire an object at the coordinate (x1,y1,z1) (guarantee S2 A2-G1) if the assumption that it is not raining is fulfilled. To reliably acquire one or a plurality of objects at the coordinate (x2,y2,z2) (guarantee S2 A2-G2), the assumption that it is not raining and that no fog is present must be fulfilled.

The accuracy/robustness of a measurement is in this connection highly dependent on the position of the objects relative to the sensor. This may mean for objects at a larger distance that stricter assumptions must be fulfilled. In this example, the position x2,y2,z2 is further removed from the radar sensor. This results in the additional assumption that no fog must be present to ensure that signals are not attenuated by fog, which would deteriorate the measuring accuracy to such an extent that individual objects are impossible to distinguish.

Different assumptions for objects at various distances may also apply to optical sensors, such as e.g. the camera (sensor 1). Different object classes may also have different assumptions, as some object classes are more difficult to detect than others for the corresponding image processing algorithms. To output such object classes as guarantees, it follows that stricter assumptions, e.g. regarding light conditions or other adjacent objects, must be fulfilled for reliable classification.

For example, the following pieces of environment information may be available at an exemplarily chosen point in time:

TABLE 2
Sensor 1: Camera (vehicle)

| | |
|---|---|
| Assumption S1-A1: true | Guarantee S1 A1-G1: no |
| | fog |
| Assumption S1-A2: no other | Guarantee S1 A2-G2: |
| object in the vicinity of | bicyclist at (x1, y1, z1) |
| the detected object | |
| Assumption S1-A3: no | Guarantee S1 A3-G3: |
| reflecting surface in the | pedestrian at (x2, y2, z2) |
| vicinity of the acquired | |
| object | |

Sensor 2: Radar (vehicle)

| | |
|---|---|
| Assumption S2-A1: no rain | Guarantee S2 A1-G1: |
| | single object at |
| | (x1, y1, z1) |
| Assumption S2-A2: no rain & | Guarantee S2 A2-G2: |
| no fog | object(s) at (x2, y2, z2) |

Sensor 3: Rain (weather transmitter)

| | |
|---|---|
| Assumption S3-A1: true | Guarantee S3 A1-G1: no |
| | rain |

For example, it may turn out that it is not possible to fulfill the contract for the camera having the assumption S1-A3: no reflecting surface in the vicinity of the acquired object, for the guarantee of environment information S1 A3-G3: pedestrian at (x2,y2,z2). As a result, this piece of environment information 52 is not considered when calculating world model 51. All other pieces of environment information allow for generating a consistent world model 51. Although it comprises an object at the coordinate x2,y2,z2, this object is not classified.

The contracts 61, 62, 63 of all pieces of environment information are now represented as clauses in a logic program by fusion component 54. A stable model indicating the currently existing guarantees may thus be derived with the aid of established methods such as ASP. Since these guarantees comprise the pieces of environment information, the stable model also represents a trustworthy world model. The guarantees of the individual sensors 1, 2, 3 are only considered valid for the world model if the corresponding assumptions can be fulfilled. In this example, this means that A3-G3 of sensor 1 (camera) cannot be used, and thus the pieces of information in this guarantee cannot be used because the assumption cannot be fulfilled. The other contract may be resolved by fusion block 54 and may contribute to world model 51. The resulting world model thus comprises the bicyclist detected at (x1,y1,z1) and an object at (x2,y2,z2). Since the guarantee S1 A3-G3 of camera 1 is not fulfilled, it is not possible to classify the object as a pedestrian.

The unfulfilled assumptions may be used as a performance indicator for an operative area. For example, if certain assumptions are frequently impossible to fulfill in certain situations (e.g., at a location, under weather conditions etc.), the analysis of these unfulfilled assumptions may be used during operation to assess and evaluate the entire distributed perception system. To improve the robustness of the distributed perception system in these situations, additional sensors may for example be installed to provide environment information that makes it possible to fulfill these assumptions for future events.

Device 50 additionally comprises a planner component 56 that is configured to calculate and transmit to the automated vehicle one or more safe trajectories for the automated vehicle based on at least one world model 51 calculated by fusion component 54.

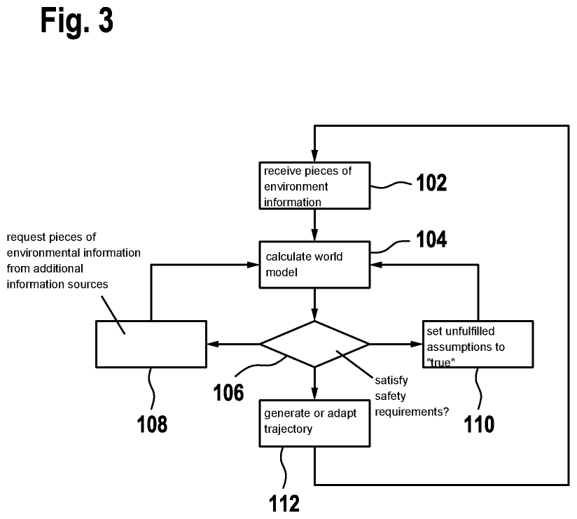

FIG. 3 shows in a schematic manner a sequence of a method for modeling the surroundings of an automated vehicle according to one specific embodiment of the present invention.

In a first step 102, pieces of environment information are received from a plurality of currently available vehicle-based and/or vehicle-external information sources, each information source providing one or more pieces of environment information. A formal assumption and a formal guarantee are associated with every piece of environment information in such a way that it is guaranteed, if the formal assumption associated with the respective environment information is fulfilled, that the piece of environment information fulfills the formal guarantee associated with it. The information about the formal assumptions and guarantees (contracts) are also received by the vehicle-based and/or vehicle-external information sources.

In the subsequent step 104, at least one world model of the surroundings of the automated vehicle is calculated with the aid of the received pieces of environment information and the associated assumptions and guarantees. This occurs in such a way that a piece of environment information is used for calculating the world model at a given point in time only if the formal assumption associated with this environment information fulfilled at this point in time.

In step 106, the world model is checked to verify that it satisfies the safety requirements of the automated vehicle, i.e., whether the world model enables planning a safe trajectory for the vehicle. If this is not the case, pieces of environment information of additional information sources, for example further environment sensors outside of the vehicle, may be requested in step 108, including the associated assumptions and guarantees. Based on this additional environment information and the associated assumptions and guarantees, another attempt may be made in step 104 to calculate a stable world model.

Alternatively or in addition, certain unfulfilled assumptions may be gradually set to “true” in step 110 and another attempt may be made in step 104 to calculate a stable world model under these modified contract conditions. In particular, a plurality of stable world models may be derived for these modified assumptions. In view of the available pieces of information, these stable world models represent different possibilities of the real world. For a guaranteed safe behavior in the real world, the planner component must then find a trajectory that is safe in all of these stable world models.

If the check in step 106 reveals that the world model fulfills the requirements for the safety of an automated vehicle, one or several trajectories for the automated vehicle are generated or adapted in step 112 and made available to the automated vehicle.

The present invention thus describes the application of the concept of contract-based design to the application case of distributed perception. The present invention makes it possible to determine a stable world model during runtime even if the availability of information sources such as environment sensors changes dynamically during runtime and the inference to the world model must be drawn continuously.

1-17. (canceled)

18. A method for modeling surroundings of an automated vehicle in which environment information is continuously received by a plurality of currently available vehicle-based and/or vehicle-external information sources, the method comprising the following steps:
providing, by each information source of the information sources, one or more pieces of environment information, wherein a formal assumption and a formal guarantee are associated with every respective piece of the pieces of environment information in such a way that it is guaranteed, when the formal assumption associated with the respective piece of environment information is fulfilled, that the respective piece of environment information fulfills the formal guarantee associated with the respective piece of environment information, wherein each of the information sources provides the associated formal assumptions and formal guarantees for the pieces of environment information it supplies; and
calculating at least one world model of the surroundings of the automated vehicle, using the received pieces of environment information and the associated assumptions and guarantees, the at least one world model being calculated in such a way that a piece of environment information is used for calculating the world model at a given point in time only when the formal assumption associated with the piece of environment information is fulfilled at the point in time.

19. The method as recited in claim 18, wherein a check as to whether the formal assumptions associated with the pieces of environment information are fulfilled is performed during runtime.

20. The method as recited in claim 18, wherein the information sources include vehicle-internal and/or vehicle-external environment sensors, the respective environment information being generated from measuring data acquired by a corresponding one of the environment sensors.

21. The method as recited in claim 18, wherein one or several pieces of environment information include: (i) weather information, and/or (ii) information about sizes and/or positions and/or speeds and/or movement directions of objects in the surroundings of the vehicle, and/or (iii) object classes, and/or (iv) object lists, and/or information about open spaces.

22. The method as recited in claim 18, wherein a formal guarantee of a piece of environment information serves as a formal assumption for at least one other piece of environment information, and the world model is calculated in such a way that as many formal assumptions as possible are fulfilled.

23. The method as recited in claim 18, wherein a number of the pieces of environment information that were not used due to unfulfilled formal assumptions is determined and from the determined number, a quality measure for the world model is determined.

24. The method as recited in claim 23, wherein the world model is used further by the automated vehicle only when a specific quality measure is reached.

25. The method as recited in claim 23, wherein environment information of additional information sources is requested when a specific quality measure is not reached, each additional information source having a set of formal assumptions and formal guarantees associated with it.

26. The method as recited in claim 18, wherein a future world model is calculated based on a current world model.

27. The method as recited in claim 18, wherein one or more safe trajectories are calculated for the automated vehicle using at least a current world model.

28. The method as recited in claim 27, wherein the one or more safe trajectories are also calculated using a future world model.

29. The method as recited in claim 18, wherein at least one piece of environment information is provided, whose formal assumption is always fulfilled or assumed to be fulfilled.

30. The method as recited in claim 18, wherein those of the formal assumptions that are rarely or never fulfilled are identified, and additional information sources are provided based on the identification.

31. The method as recited in claim 30, wherein the additional information sources include infrastructure sensors that supply pieces of environment information capable of fulfilling the identified formal assumptions.

32. The method as recited in claim 18, wherein one or more of the information sources are configured as a camera and/or radar sensor and/or rain sensor and/or lidar sensor and/or pressure sensor and/or GPS receiver and/or as a data service for environment data for weather data and/or traffic information and/or traffic control information.

33. A device, comprising:
a fusion component configured to continuously receive environment information from a plurality of vehicle-based and/or vehicle-external information sources and, depending on the received environment information, to calculate at least one world model of an automated vehicle, the fusion component being configured to use a piece of environment information of an information source at a given point in time for calculating the world model only if formal assumptions associated with the piece of environment information are fulfilled at the point in time, wherein a check whether the formal assumptions associated with a piece of environment information are fulfilled is performed during runtime.

34. The device as recited in claim 33, further comprising:
a planner component configured to calculate one or more safe trajectories for the automated vehicle, based on at least one world model calculated by the fusion component, and to provide the trajectory/trajectories to the automated vehicle.

35. A vehicle configured for automated driving, comprising:
at least one environment sensor system; and
a device including a fusion component configured to continuously receive environment information from a plurality of vehicle-based and/or vehicle-external information sources and, depending on the received environment information, to calculate at least one world model of an automated vehicle, the fusion component being configured to use a piece of environment information of an information source at a given point in time for calculating the world model only if formal assumptions associated with the piece of environment information are fulfilled at the point in time, wherein a check whether the formal assumptions associated with a piece of environment information are fulfilled is performed during runtime.

36. A non-transitory computer-readable medium on which is stored a computer program including program code for modeling surroundings of an automated vehicle in which environment information is continuously received by a plurality of currently available vehicle-based and/or vehicle-external information sources, the program code, when executed by a computer, causing the computer to perform the following steps:
providing, by each information source of the information sources, one or more pieces of environment information, wherein a formal assumption and a formal guarantee are associated with every respective piece of the environment information in such a way that it is guaranteed, when the formal assumption associated with the respective piece of environment information is fulfilled, that the respective piece of environment information fulfills the formal guarantee associated with the respective piece of environment information, wherein each of the information sources provides the associated formal assumptions and formal guarantees for the pieces of environment information it supplies; and
calculating at least one world model of the surroundings of the automated vehicle, using the received pieces of environment information and the associated assumptions and guarantees, the at least one world model being calculated in such a way that a piece of environment information is used for calculating the world model at a given point in time only when the formal assumption associated with the piece of environment information is fulfilled at the point in time.
